(19) United States
(12) Patent Application Publication
(10) Pub. No.: US 2018/0231094 A1
(43) Pub. Date: Aug. 16, 2018

(54) MAGNETO-RHEOLOGICAL FLUID DAMPER

(71) Applicant: KYB Corporation, Tokyo (JP)

(72) Inventors: Keiji SAITO, Tokyo (JP); Yasuhiro YONEHARA, Kanagawa (JP); Atsushi OGAWA, Kanagawa (JP)

(73) Assignee: KYB Corporation, Tokyo (JP)

(21) Appl. No.: 15/751,849

(22) PCT Filed: Jul. 4, 2016
(86) PCT No.: PCT/JP2016/069819

§ 371 Date: Feb. 9, 2018

(30) Foreign Application Priority Data
Sep. 8, 2015 (JP) 2015-176890

(51) Int. Cl. F16F 9/53; F16F 9/19; F16F 9/32; F16F 15/00; F16F 15/03

(52) U.S. Cl. CPC F16F 9/535; F16F 9/19; F16F 15/03; F16F 15/005; F16F 9/3214

(57) ABSTRACT

A damper includes a cylinder that seals a magneto-rheological fluid, a piston slidably disposed in the cylinder, and a piston rod coupled to the piston. The piston includes a piston core, a flux ring, a plate, and a fixing nut. The piston core is mounted on the piston rod. The piston core has an outer periphery on which a coil is disposed. The flux ring forms a flow passage for the magneto-rheological fluid with the piston core. The plate is disposed on an outer periphery of the piston rod, has an outer peripheral surface housed in a one-end of the flux ring, and is bonded on the flux ring by brazing. The fixing nut sandwiches the plate with the piston core.

### TECHNICAL FIELD

The present invention relates to a magneto-rheological fluid damper that uses a magneto-rheological fluid whose apparent viscosity varies due to an action of a magnetic field.

### BACKGROUND ART

As a damper mounted on a vehicle such as an automobile, there is a damper where a magnetic field is activated on a flow passage through which a magneto-rheological fluid passes so as to vary an apparent viscosity of the magneto-rheological fluid to vary a damping force. JP2008-175364A discloses a magneto-rheological fluid damper where a piston assembly includes a piston core that has an outer periphery on which a coil is wound around and a piston ring disposed on the outer periphery of the piston core, and when the piston assembly slides inside a cylinder, a magneto-rheological fluid passes through a flow passage formed between the piston core and the piston ring.

### SUMMARY OF INVENTION

However, the magneto-rheological fluid damper described in JP2008-175364A includes a pair of plates that axially sandwiches the piston ring, and fixes the respective plates by fastening with nuts, in order to dispose the piston ring at a predetermined position with respect to the piston core. Thus, having a configuration that fixes the piston ring by sandwiching with the plates and the nuts from both ends, there is a possibility that a whole length of the piston assembly becomes long, and a stroke length of the piston assembly becomes short.

It is an object of the present invention to shorten a whole length of a piston of a magneto-rheological fluid damper.

According to one aspect of the present invention, a magneto-rheological fluid damper includes a cylinder configured to seal a magneto-rheological fluid, the magneto-rheological fluid having an apparent viscosity that varies due to an action of a magnetic field; a piston slidably disposed in the cylinder, the piston defining a pair of fluid chambers in the cylinder; and a piston rod coupled to the piston to extend to an outside of the cylinder. The piston includes a piston core mounted on an end portion of the piston rod, the piston core having an outer periphery on which a coil is disposed; a ring body that surrounds the outer periphery of the piston core, the ring body forming a flow passage for the magneto-rheological fluid with the piston core; a plate formed into a ring shape to be disposed on the outer periphery of the piston rod, the plate having an outer edge housed in one end of the ring body, the plate being bonded on the ring body by a metal layer by brazing; and a stopper that sandwiches the plate with the piston core.

### BRIEF DESCRIPTION OF DRAWINGS

FIG. 1 is a cross-sectional view of the front side of a magneto-rheological fluid damper according to an embodiment of the present invention;

FIG. 2 is a left side view of a piston in FIG. 1;

FIG. 3 is a right side view of the piston in FIG. 1;

FIG. 4 is an enlarged view of a bonding portion of a plate and a ring body in FIG. 1; and

FIG. 5 is a cross-sectional view of the front side of a magneto-rheological fluid damper according to a modification of the embodiment of the present invention.

### DESCRIPTION OF EMBODIMENTS

The following describes an embodiment of the present invention with reference to the drawings.

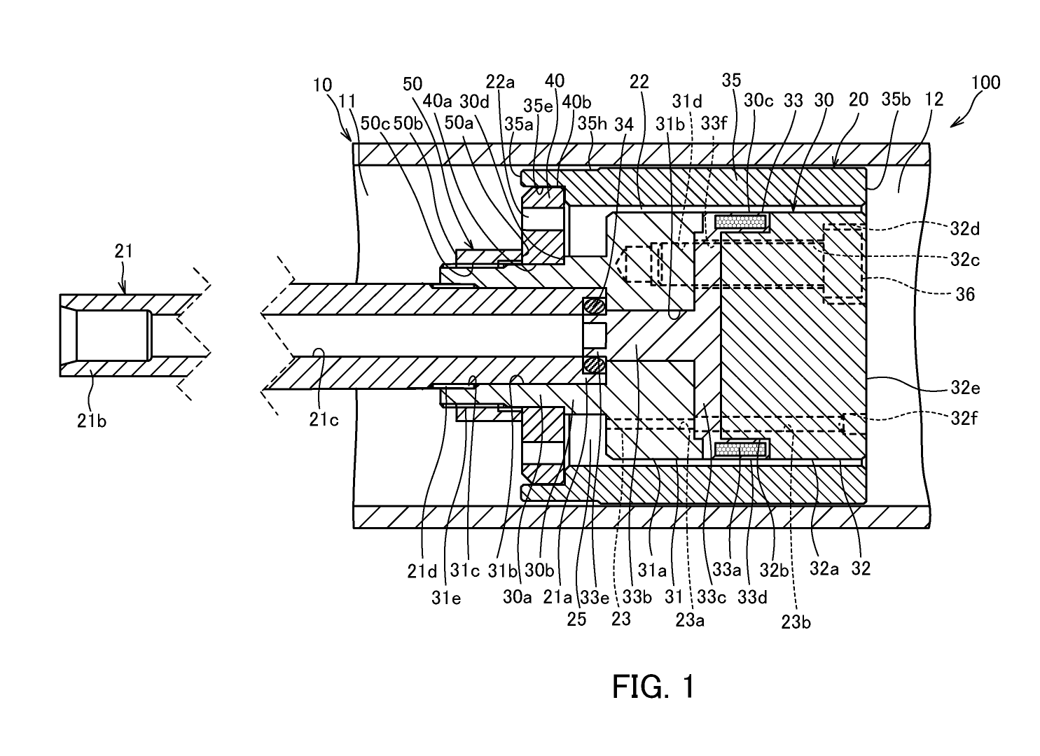

First, the following describes an overall configuration of a magneto-rheological fluid damper (hereinafter simply referred to as a “damper”) 100 according to the embodiment of the present invention with reference to FIG. 1.

The damper 100 is a damper that can change an attenuation coefficient by the use of magneto-rheological fluid, which varies a viscosity according to an action of a magnetic field. The damper 100 is, for example, interposed between a vehicle body and a wheel shaft in a vehicle such as an automobile. The damper 100 generates the damping force that reduces vibrations of the vehicle body through extension and contraction.

The damper 100 includes a cylinder 10 that internally seals the magneto-rheological fluid, a piston 20 slidably disposed in the cylinder 10, and a piston rod 21 coupled to the piston 20 to extend to an outside of the cylinder 10.

The cylinder 10 is formed into a closed-bottomed cylindrical shape. The magneto-rheological fluid sealed in the cylinder 10 varies an apparent viscosity by the action of the magnetic field. The magneto-rheological fluid is liquid produced by dispersing microparticles with ferromagnetism in liquid such as an oil. The viscosity of the magneto-rheological fluid varies according to a strength of the magnetic field acting on the magneto-rheological fluid. When the magneto-rheological fluid is free from the influence of the magnetic field, the magneto-rheological fluid returns to an original state.

A gas chamber (not illustrated) to seal gas is defined via a free piston (not illustrated) in the cylinder 10. The gas chamber that is provided in the cylinder 10 compensates a volume change in the cylinder 10 by advance and retreat of the piston rod 21.

The piston 20 defines a fluid chamber 11 and a fluid chamber 12 in the cylinder 10. The piston 20 includes a ring-shaped flow passage 22 capable of moving through the magneto-rheological fluid between the fluid chamber 11 and the fluid chamber 12, and a bypass flow passage 23 that is a through-hole. The piston 20 can slide inside the cylinder 10 where the magneto-rheological fluid passes through the flow passage 22 and the bypass flow passage 23. Details of a configuration of the piston 20 will be described later.

The piston rod 21 is formed coaxially with the piston 20. An one-end 21a of the piston rod 21 is fixed to the piston 20, and an other-end 21b extends to the outside of the cylinder 10. The piston rod 21 is formed into a cylindrical shape where the one-end 21a and the other-end 21b open. Through an inner periphery 21c of the piston rod 21, a pair of wirings (not illustrated) that supply current to a coil 33a, which is described later, of the piston 20 is passed. A male screw 21d screwed with the piston 20 is formed on an outer periphery near the one-end 21a of the piston rod 21.

The following describes a configuration of the piston 20 with reference to FIG. 1 to FIG. 3.

The piston 20 includes a piston core 30 including a small-diameter portion 30a, an enlarged diameter portion 30b, and a large-diameter portion 30c. The small-diameter portion 30a is mounted on an end portion of the piston rod 21. The enlarged diameter portion 30b is formed to have a large diameter compared with the small-diameter portion 30a and axially continuous with the small-diameter portion 30a to form a stepped portion 30d with the small-diameter portion 30a. The large-diameter portion 30c is formed to have a large diameter compared with the enlarged diameter portion 30b and axially continuous with the enlarged diameter portion 30b. The large-diameter portion 30c also has the coil 33a that is provided on an outer periphery thereof.

The piston 20 includes a flux ring 35, a plate 40, and a fixing nut 50. The flux ring 35 is a ring body that surrounds an outer periphery of the piston core 30 to form the flow passage 22 for the magneto-rheological fluid between the piston core 30. The plate 40 is formed into a ring shape to be disposed on an outer periphery of the small-diameter portion 30a, and mounted on an one-end 35a of the flux ring 35. The fixing nut 50 is a stopper mounted on the small-diameter portion 30a to sandwich the plate 40 with the stepped portion 30d.

The piston core 30 includes a first core 31, a coil assembly 33, a second core 32, and a pair of bolts 36. The first core 31 is mounted on an end portion of the piston rod 21. The coil assembly 33 has an outer periphery on which the coil 33a is disposed. The second core 32 sandwiches the coil assembly 33 with the first core 31. The pair of bolts 36 are fastening members that fasten the second core 32 and the coil assembly 33 to the first core 31.

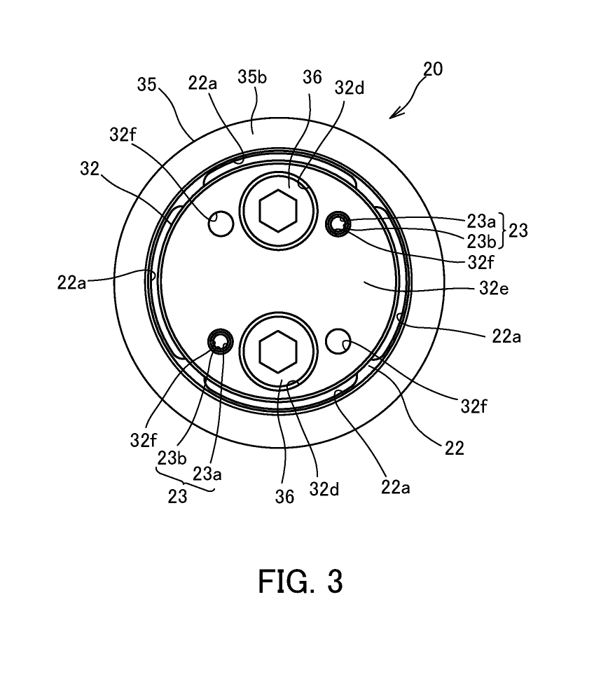

The piston core 30 includes the bypass flow passage 23 formed by axially passing through the piston core 30, on a position less influenced by the magnetic field generated by the coil 33a compared with the flow passage 22. The bypass flow passage 23 includes a first through-hole 23a and a second through-hole 23b. The first through-hole 23a is formed by passing through the first core 31. The second through-hole 23b is formed by passing through the second core 32. The first through-hole 23a and the second through-hole 23b are formed so as to avoid a coupling portion 33c, which is described below, of the coil assembly 33. The bypass flow passage 23 is formed at two positions at intervals of 180° as illustrated in FIG. 3. Not limited to this, the number of the bypass flow passage 23 may be arbitrary, or the bypass flow passage 23 may be omitted.

The first core 31 includes the small-diameter portion 30a, the enlarged diameter portion 30b, a large-diameter portion 31a that forms a part of the large-diameter portion 30c of the piston core 30, a through-hole 31b that axially passes through the center, and the first through-hole 23a that forms a part of the bypass flow passage 23.

The small-diameter portion 30a is formed into a cylindrical shape that axially projects from the flux ring 35. A female screw 31c screwed with the male screw 21d of the piston rod 21 is formed on an inner periphery of the small-diameter portion 30a. The piston core 30 is fastened to the piston rod 21 by the screwing of the male screw 21d with the female screw 31c.

The enlarged diameter portion 30b is formed into a cylindrical shape. The enlarged diameter portion 30b is coaxially formed continuous with the small-diameter portion 30a. Between the small-diameter portion 30a and the enlarged diameter portion 30b, the ring-shaped stepped portion 30d is formed. The plate 40 abuts on the stepped portion 30d. The stepped portion 30d sandwiches the plate 40 with the fixing nut 50. On an outer periphery of a distal end of the small-diameter portion 30a, a male screw 31e screwed with a female screw 50c of the fixing nut 50 is formed in a state sandwiching the plate 40.

The large-diameter portion 31a is formed into a cylindrical shape. The large-diameter portion 31a is coaxially formed continuous with the enlarged diameter portion 30b. An outer periphery of the large-diameter portion 31a faces the flow passage 22 through which the magneto-rheological fluid passes. The large-diameter portion 31a abuts on the coil assembly 33. A cylinder portion 33b, which is described later, of the coil assembly 33 is inserted into and fitted to the through-hole 31b of the large-diameter portion 31a. On the large-diameter portion 31a, a pair of female screws 31d screwed with the bolts 36 are formed.

The first through-hole 23a axially passes through the large-diameter portion 31a of the first core 31. The first through-hole 23a are formed at two positions at intervals of 180° as illustrated in FIG. 3. Damping force characteristics when the piston 20 slides are set depending on a hole diameter of the first through-hole 23a.

The second core 32 includes a large-diameter portion 32a, a small-diameter portion 32b, a through-hole 32c, a deep counterbored portion 32d, the second through-hole 23b, and a plurality of tool holes 32f. The large-diameter portion 32a forms a part of the large-diameter portion 30c of the piston core 30. The small-diameter portion 32b is formed on one end of the large-diameter portion 32a, having a small diameter compared with the large-diameter portion 32a. The bolt 36 passes through the through-hole 32c. A head of the bolt 36 is engaged with the deep counterbored portion 32d. The second through-hole 23b forms a part of the bypass flow passage 23. A tool (not illustrated) for rotating the piston 20 is engaged with the plurality of tool holes 32f.

The large-diameter portion 32a is formed into a columnar shape. The large-diameter portion 32a is formed to have a diameter identical to that of the large-diameter portion 31a of the first core 31. An outer periphery of the large-diameter portion 32a faces the flow passage 22 through which the magneto-rheological fluid passes. The large-diameter portion 32a is formed such that an end surface 32e that faces the fluid chamber 12 is a flat surface with an other-end 35b of the flux ring 35.

The small-diameter portion 32b is formed into a columnar shape coaxially with the large-diameter portion 32a. The small-diameter portion 32b is formed having a diameter identical to that of an inner periphery of a coil mold portion 33d, which is described later, of the coil assembly 33, and is fitted to the inner periphery of the coil mold portion 33d.

A pair of through-holes 32c are formed by axially passing through the second core 32. The through-hole 32c is formed to have a large diameter compared with a diameter of an engagement portion of the bolt 36. The through-hole 32c is formed to be coaxial with the female screw 31d of the first core 31 in a state where the piston core 30 has been assembled.

The deep counterbored portion 32d is formed on an end portion of the through-hole 32c. The deep counterbored portion 32d is formed to have a large diameter compared with the through-hole 32c and the head of the bolt 36. The deep counterbored portion 32d is formed having a depth capable of completely housing the head of the bolt 36. When the bolt 36 inserted through the through-hole 32c is screwed with the female screw 31d of the first core 31, a bottom surface of the deep counterbored portion 32d is pressed to the first core 31, and the second core 32 is pressed to the first core 31.

The second through-hole 23b is formed to have a large diameter compared with the first through-hole 23a. The second through-hole 23b is formed at two positions at intervals of 180° as illustrated in FIG. 3. The second through-hole 23b is formed to be coaxial with the first through-hole 23a in the state where the piston core 30 has been assembled. The hole diameter of the first through-hole 23a decides the damping force characteristics when the piston 20 slides. A hole diameter of the second through-hole 23b has no influence on the damping force characteristics when the piston 20 slides.

The tool holes 32f are holes to which the tool is fitted when the piston 20 is screwed with the piston rod 21. The tool holes 32f are formed at four positions at intervals of 90° as illustrated in FIG. 3. In the embodiment, two of the four tool holes 32f are formed on end portions of the second through-holes 23b. Thus, the tool holes 32f are commonly used as the second through-holes 23b.

The coil assembly 33 is formed by molding a resin with the coil 33a inserted. The coil assembly 33 includes the cylinder portion 33b fitted to the through-hole 31b of the first core 31, the coupling portion 33c sandwiched between the first core 31 and the second core 32, and the annular-shaped coil mold portion 33d that internally includes the coil 33a.

The coil 33a forms the magnetic field by a current supplied from the outside. A strength of this magnetic field strengthens as the current supplied to the coil 33a increases. When the current is supplied to the coil 33a and the magnetic field is formed, the apparent viscosity of the magneto-rheological fluid flowing through the flow passage 22 varies. The viscosity of the magneto-rheological fluid increases as the magnetic field by the coil 33a strengthens.

In the cylinder portion 33b, a distal end portion 33e is fitted to the inner periphery of the piston rod 21. From a distal end of the cylinder portion 33b, a pair of wirings for supplying the current to the coil 33a are extracted. Between the distal end portion 33e of the cylinder portion 33b and the one-end 21a of the piston rod 21, an O-ring 34 as a sealing member is disposed.

The O-ring 34 is axially compressed by the large-diameter portion 31a of the first core 31 and the piston rod 21 and is radially compressed by the distal end portion 33e of the coil assembly 33 and the piston rod 21. This prevents an outflow and a leakage of the magneto-rheological fluid invaded between an outer periphery of the piston rod 21 and the first core 31 and between the first core 31 and the coil assembly 33 to the inner periphery of the piston rod 21.

The coupling portion 33c is radially disposed to extend in a straight line from a base portion of the cylinder portion 33b to the coil mold portion 33d, thus coupling the cylinder portion 33b to the coil mold portion 33d. Inside the coupling portion 33c and the cylinder portion 33b, the pair of wirings that supply the current to the coil 33a pass through.

The coil mold portion 33d is disposed into a ring shape upright on an outer circumference of the coupling portion 33c. The coil mold portion 33d is formed to project from an end portion at an opposite side of the cylinder portion 33b in the coil assembly 33. The coil mold portion 33d is formed to have a diameter identical to that of the large-diameter portion 31a of the first core 31. An outer periphery of the coil mold portion 33d forms a part of the large-diameter portion 30c of the piston core 30. The coil mold portion 33d internally includes the coil 33a.

Thus, the piston core 30 is formed by being divided into the three members, the first core 31, the second core 32, and the coil assembly 33. Accordingly, it is only necessary to only form the coil assembly 33 that includes the coil 33a by molding, and to sandwich the coil assembly 33 between the first core 31 and the second core 32. It is easy to form the piston core 30 compared with the case where the piston core 30 alone is formed and molding work is performed.

In the piston core 30, while the first core 31 is fixed to the piston rod 21, the coil assembly 33 and the second core 32 are only axially fitted. Therefore, in the piston 20, the second core 32 and the coil assembly 33 are fixed as pressing to the first core 31 by fastening the pair of bolts 36.

The bolt 36 is inserted into the through-hole 32c of the second core 32 to be screwed with the female screw 31d of the first core 31. The bolt 36, by its fastening power, presses the bottom surface of the deep counterbored portion 32d to the first core 31. This sandwiches the coil assembly 33 between the second core 32 and the first core 31. Thus, the piston core 30 is integrated. The through-hole 32c and the female screw 31d are formed at positions where the bolt 36 does not interfere with the coupling portion 33c by avoiding the coupling portion 33c of the coil assembly 33.

Thus, the second core 32 and the coil assembly 33 are pressed to be fixed to the first core 31 by only fastening the bolt 36. This allows easy assembly of the piston core 30.

The flux ring 35 is formed into an approximately cylindrical shape. An outer peripheral surface 35c of the flux ring 35 has an outer diameter formed to be approximately identical to an inner diameter of the cylinder 10. An inner peripheral surface 35d of the flux ring 35 has an inner diameter formed to be larger than the outer diameter of the piston core 30. Between the flux ring 35 and the piston core 30, the flow passage 22 is formed.

The flux ring 35 further includes an annular recess 35e formed as axially hollowing in a depressed shape from the one-end 35a, and a small-diameter portion 35h disposed on a side of the one-end 35a and formed to have a small outer diameter compared with the outer peripheral surface 35c. An axial length of the small-diameter portion 35h is set equal to or more than an axial depth of the annular recess 35e.

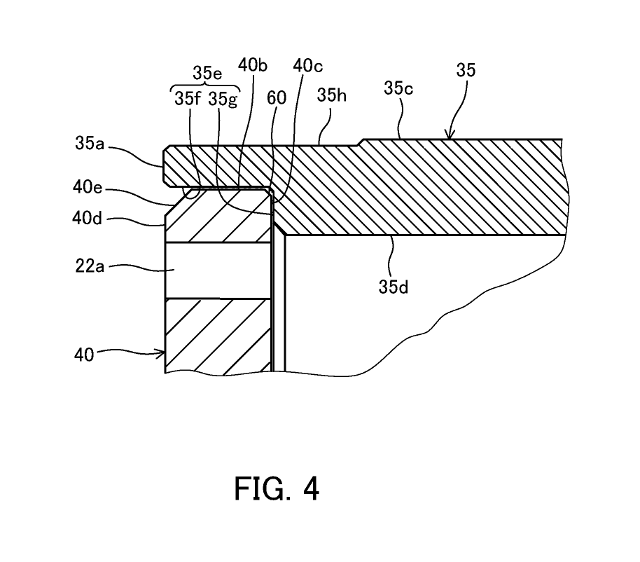

The plate 40 is a plate member formed into an annular shape. An outer peripheral surface 40b as an outer edge of the plate 40 is pressed into the annular recess 35e, thus the plate 40 is housed in the annular recess 35e. A structure of a bonding portion of the plate 40 and the flux ring 35 will be described later in detail with reference to FIG. 4. It should be noted that the plate 40 may be housed such that the outer peripheral surface 40b is screwed with the annular recess 35e or is engaged with the annular recess 35e with a backlash.

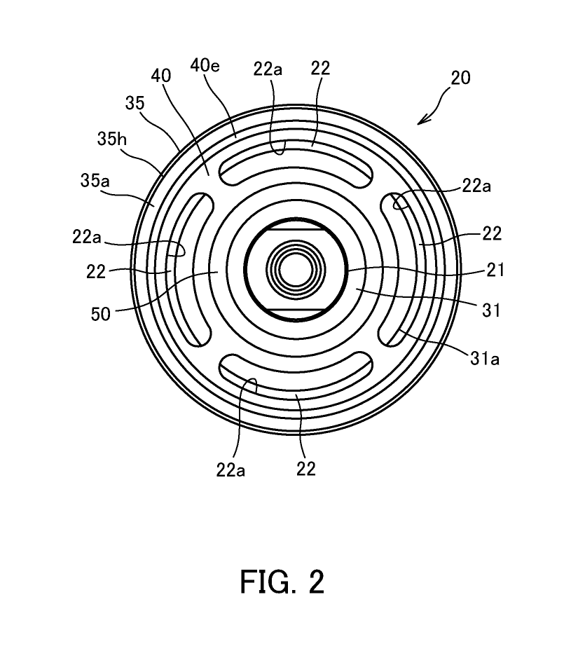

As illustrated in FIG. 2, the plate 40 includes a plurality of flow passages 22a, which are through-holes communicating with the flow passage 22. The flow passages 22a are formed into an arc shape and are disposed at angular intervals. In the embodiment, the flow passages 22a are formed at four positions at intervals of 90°. The flow passages 22a are not limited to be the arc shape but may be, for example, a plurality of circular through-holes.

Between the plate 40 and the large-diameter portion 30c of the piston core 30, a bypass branch passage 25 that leads the magneto-rheological fluid flown from the flow passage 22a to the bypass flow passage 23 is formed. The bypass branch passage 25 is a ring-shaped void formed on an outer periphery of the enlarged diameter portion 30b.

The magneto-rheological fluid flown from the flow passages 22a into the piston core 30 flows through the flow passage 22 and the bypass flow passage 23 via the bypass branch passage 25. Accordingly, it is not necessary to match relative positions in a circumferential direction of the flow passage 22a and the bypass flow passage 23, thus facilitating the assembly of the piston 20.

A through-hole 40a to which the small-diameter portion 30a of the first core 31 fits is formed at an inner periphery of the plate 40. Fitting the small-diameter portion 30a to the through-hole 40a secures coaxiality of the plate 40 with the first core 31.

Then, a fastening power by the fixing nut 50 to the small-diameter portion 30a of the piston core 30 presses the plate 40 to the stepped portion 30d to be sandwiched. This specifies an axial position of the flux ring 35 fixed to the plate 40 with respect to the piston core 30.

The fixing nut 50 is formed into an approximately cylindrical shape and is mounted to the outer periphery of the small-diameter portion 30a of the piston core 30. A distal end portion 50a of the fixing nut 50 abuts on the plate 40. The female screw 50c screwed with the male screw 31e of the first core 31 is formed on an inner periphery of a base end portion 50b of the fixing nut 50. This screws the fixing nut 50 with the small-diameter portion 30a. On an outer peripheral surface of the fixing nut 50, an engaging surface (not illustrated) with which a tool for fastening is engaged is formed. The engaging surface has at least two parallel planar surfaces. A cross-sectional outer diameter of the fixing nut 50 is, for example, a regular hexagon.

Thus, the flux ring 35 is coupled to the piston core 30 by the plate 40 disposed on the one-end 35a side of the flux ring 35 such that a central axis of the flux ring 35 corresponds to a central axis of the piston core 30. Furthermore, the axial position of the flux ring 35 with respect to the piston core 30 is specified by the plate 40. This eliminates a need for disposing a member that couples the flux ring 35 to the piston core 30 to specify the axial position of the flux ring 35 on the other-end 35b side of the flux ring 35. Accordingly, the whole length of the piston 20 of the damper 100 can be shortened.

Since the member that couples the flux ring 35 to the piston core 30 is not disposed on the other-end 35b side of the flux ring 35, the flow passage 22 is open continuously in a ring shape on the other-end 35b side, as illustrated in FIG. 3. This reduces a flow resistance of the flow passage 22 so as to reduce a resistance provided on the magneto-rheological fluid passing through the flow passage 22.

The following describes the bonding portion of the plate 40 and the flux ring 35 in detail with reference to FIG. 4. It should be noted that, in FIG. 4, for ease of understanding, a space between the annular recess 35e of the flux ring 35 and the plate 40 is largely illustrated.

As illustrated in FIG. 4, the annular recess 35e of the flux ring 35 includes an inner peripheral surface 35f formed to have an inner diameter larger than that of the inner peripheral surface 35d, and a stepped portion 35g as a bottom surface of the annular recess 35e that couples the inner peripheral surface 35f to the inner peripheral surface 35d.

In the plate 40 housed in the annular recess 35e, the outer peripheral surface 40b is pressed into the inner peripheral surface 35f, and a one-end surface 40c abuts on the stepped portion 35g. Thus, the axial position of the flux ring 35 with respect to the piston core 30 is specified by abutting the stepped portion 35g of the annular recess 35e on the one-end surface 40c of the plate 40.

As illustrated in FIG. 4, the plate 40 further includes a chamfered portion 40e formed at a corner portion between the outer peripheral surface 40b and an other-end surface 40d. In a space between the chamfered portion 40e and the inner peripheral surface 35f, before brazing, a metal used for brazing is placed.

The melted metal in brazing flows into between the outer peripheral surface 40b and the inner peripheral surface 35f and between the one-end surface 40c and the stepped portion 35g by capillarity, and coagulates after cooling. This forms a metal layer 60 between the outer peripheral surface 40b and the inner peripheral surface 35f and between the one-end surface 40c and the stepped portion 35g. In view of this, the outer peripheral surface 40b of the plate 40 is pressed into the inner peripheral surface 35f of the annular recess 35e, and further, the metal layer 60 is disposed. Therefore, the flux ring 35 and the plate 40 are strongly bonded.

It should be noted that it is only necessary that the metal layer 60 is formed at least any one of between the outer peripheral surface 40b and the inner peripheral surface 35f and between the one-end surface 40c and the stepped portion 35g. The brazing is performed such that the metal does not leak out from a region where the flux ring 35 makes a surface contact with the plate 40.

The space where the metal used for brazing is placed is not limited to the above-described configuration, and may be formed such that a chamfered portion is disposed on the flux ring 35 side, or may be formed such that the chamfered portions are disposed at both of the flux ring 35 and the plate 40.

The metal layer 60 is made of a copper based metal. It is not limited this, and depending on the materials of the flux ring 35 and the plate 40, other metal such as nickel or argentum may be used.

As described above, the flux ring 35 and the plate 40 are bonded by press fitting and the metal layer 60 by brazing. Accordingly, compared with a case bonded by, for example, crimping or fastening, the bond is facilitated, and a sufficient coupling strength can be obtained.

The following describes an assembly procedure of the piston 20.

Firstly, the piston core 30 is assembled. First, the second core 32 is mounted on the coil assembly 33. The mounting is performed such that the small-diameter portion 32b of the second core 32 is fitted to the inner periphery of the coil mold portion 33d of the coil assembly 33.

Next, the first core 31 is mounted on an assembly of the coil assembly 33 and the second core 32. The cylinder portion 33b of the coil assembly 33 is inserted into the through-hole 31b of the first core 31 from the large-diameter portion 31a side, and the pair of wirings that supply the current to the coil 33a are extracted from the small-diameter portion 30a side of the through-hole 31b of the first core 31. Then, the pair of bolts 36 are inserted through the through-holes 32c of the second core 32 to be screwed with the female screw 31c of the first core 31. This fastening of the bolts 36 completes the assembly of the piston core 30.

Concurrently with the assembly of the piston core 30, the flux ring 35 and the plate 40 are integrally assembled. Specifically, the outer peripheral surface 40b of the plate 40 is pressed into the annular recess 35e of the flux ring 35, and then, the brazing is performed.

Here, an outer diameter of the small-diameter portion 35h disposed on the one-end 35a side of the flux ring 35 is set so as not to be larger than the outer diameter of the outer peripheral surface 40b, even if the one-end 35a side of the flux ring 35 radially bulges outside by the plate 40 being pressed into the annular recess 35e. In view of this, even if the plate 40 is pressed into the flux ring 35, the outer diameter on the one-end 35a side is maintained in a state smaller than the outer diameter of the outer peripheral surface 40b. As a result, a sliding surface of the cylinder 10 and the piston 20 can prevent occurrence of scoring or the like. In addition, since it is not necessary to, for example, reprocess the outer diameter of the flux ring 35 in accordance with the inner diameter of the cylinder 10 after the plate 40 is pressed into the flux ring 35, the production cost can be reduced.

The brazing is performed by heating an assembly of the flux ring 35 and the plate 40 in a state where the metal for brazing is placed in the space between the chamfered portion 40e and the inner peripheral surface 35f. At this time, if the assembly of the flux ring 35 and the plate 40 is arranged so that the other-end surface 40d of the plate 40 turns up, it can be easily visually confirmed whether the metal for brazing is placed before brazing or not. It can be easily visually confirmed from above whether the metal layer 60 is formed between the outer peripheral surface 40b and the inner peripheral surface 35f after brazing or not.

Next, the plate 40 integrally assembled with the flux ring 35 is attached to the piston core 30. Specifically, the plate 40 is fitted to the outer periphery of the small-diameter portion 30a of the first core 31 of the piston core 30 to be abutted on the stepped portion 30d of the first core 31. Then, the fixing nut 50 is screwed with the small-diameter portion 30a. This sandwiches the plate 40 between the fixing nut 50 and the stepped portion 30d. In the above-described procedure, the piston 20 is assembled.

After the piston 20 is assembled, the piston 20 is mounted on the piston rod 21. Specifically, the piston 20 is rotated around a central axis by fitting the tool to the tool holes 32f. At this time, the pair of wirings that supply the current to the coil 33a are inserted through the inner periphery 21c of the piston rod 21. This screws the female screw 31c of the first core 31 of the piston core 30 with the male screw 21d of the piston rod 21. At this time, between the distal end portion 33e of the piston rod 21 and the one-end 21a of the piston rod 21, the O-ring 34 is preliminarily inserted.

Thus, attaching the piston 20 preliminarily assembled to the piston rod 21 facilitates the assembly of the piston 20 and the piston rod 21.

It should be noted that, in this embodiment, the piston 20 is divided into the three members, the first core 31, the second core 32, and the coil assembly 33. However, instead of this configuration, the piston 20 may be divided into the two members by integrally forming the first core 31 and the coil assembly 33, or the two members by integrally forming the second core 32 and the coil assembly 33.

The following describes the actions of the damper 100.

When the damper 100 extends and contracts to cause the piston rod to advance and retreat with respect to the cylinder 10, the magneto-rheological fluid flows through the flow passage 22 and the bypass flow passage 23 via the flow passage 22a formed on the plate 40 and the bypass branch passage 25. This causes the magneto-rheological fluid to move between the fluid chamber 11 and the fluid chamber 12, thus the piston 20 slides in the cylinder 10.

At this time, the first core 31, the second core 32, and the flux ring 35, which are made of the magnetic material, of the piston core 30 constitute a magnetic path that leads a magnetic flux occurring around the coil 33a. The plate 40 is made of the non-magnetic material. Therefore, the flow passage 22 between the piston core 30 and the flux ring 35 is a magnetic gap through which the magnetic flux occurring around the coil 33a passes. This causes a magnetic field of the coil 33a to act on the magneto-rheological fluid flowing through the flow passage 22 at the extension and contraction of the damper 100.

The damping force generated by the damper 100 is adjusted by a current amount to the coil 33a being changed so as to change strength of the magnetic field that acts on the magneto-rheological fluid flowing through the flow passage 22. Specifically, as the current supplied to the coil 33a increases, the strength of the magnetic field occurring around the coil 33a increases. Accordingly, the viscosity of the magneto-rheological fluid flowing through the flow passage 22 increases to increase the damping force generated by the damper 100.

On the other hand, the bypass flow passage 23 is formed of the first through-hole 23a formed on the first core 31 of the piston core 30, and the second through-hole 23b formed on the second core 32 and the coil assembly 33. Between the piston core 30 and the plate 40, the ring-shaped bypass branch passage 25 is defined. The bypass flow passage 23 has one end that communicates with the flow passage 22a via the bypass branch passage 25, and the other end that opens to the end surface 32e of the piston 20.

The bypass flow passage 23 is defined by the first through-hole 23a and the second through-hole 23b that axially pass through the piston core 30 made of the magnetic material. The coil 33a is incorporated in an outer peripheral portion of the piston core 30. Therefore, the magneto-rheological fluid flowing through the bypass flow passage 23 is less likely to be influenced by the magnetic field of the coil 33a.

Disposing the bypass flow passage 23 reduces pressure variation that occurs when a current value of the coil 33a is adjusted. Accordingly, occurrence of impact, noise, and the like by rapid pressure variation is prevented. In the damper 100, the inner diameter and the length of the first through-hole 23a of the bypass flow passage 23 are set corresponding to required damping force characteristics.

With the above embodiment, the following efficiencies are provided.

In the damper 100, the plate 40 pressed into the one-end 35a of the flux ring 35 and bonded by brazing is sandwiched between the fixing nut 50 and the stepped portion 30d of the piston core 30, and thereby the flux ring 35 is axially fixed to the piston core 30. In view of this, it is not necessary to dispose a member for fixing the flux ring 35 to the piston core 30 on the other-end 35b side of the flux ring 35. Accordingly, the whole length of the piston 20 of the damper 100 can be shortened.

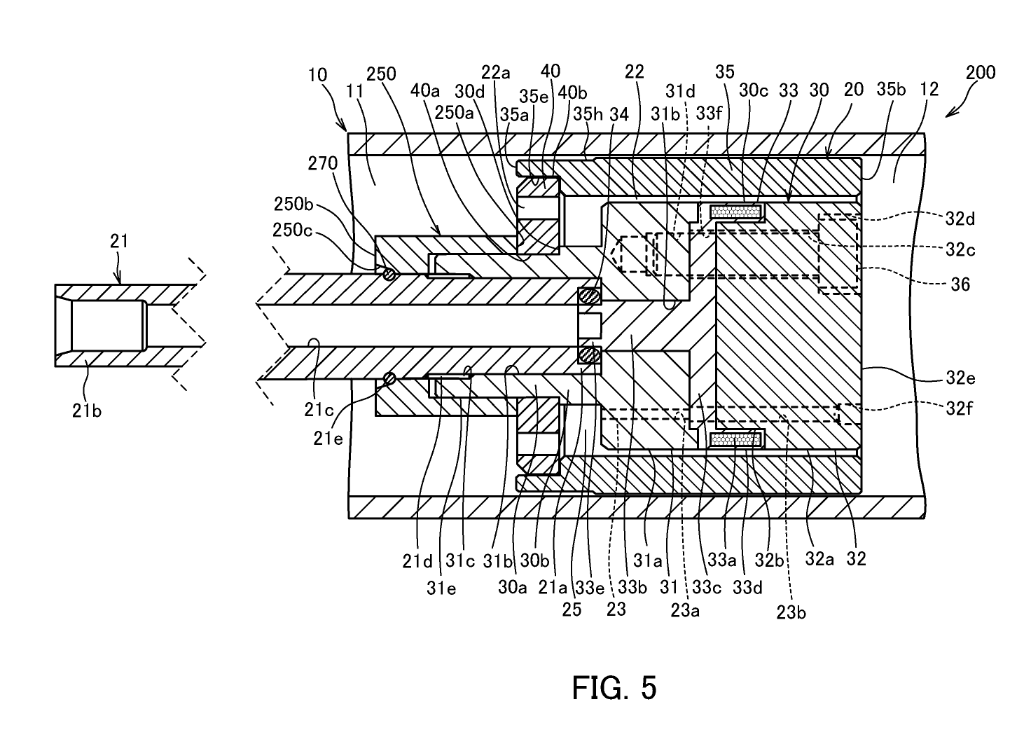

The following describes a magneto-rheological fluid damper (hereinafter simply referred to as a “damper”) 200 according to a modification of the embodiment of the present invention, with reference to FIG. 5. It should be noted that, in the modification, components that are the same as those in the above-described embodiment are assigned the same reference numerals, and therefore such components will not be further elaborated here.

The damper 200 is different from the damper 100 according to the above-described embodiment, in that the plate 40 is fixed using a C-ring 270 as a retaining ring, not the fixing nut 50.

On the outer periphery near the one-end 21a of the piston rod 21, corresponding to a position on which the C-ring 270 is disposed, a ring groove 21e formed into a shape corresponding to an outer shape of the C-ring 270 is formed.

A stopper 250 is formed into an approximately cylindrical shape to be fitted to the outer periphery of the small-diameter portion 30a of the first core 31. In the stopper 250, a distal end portion 250a abuts on the plate 40. The stopper 250 includes a tapered portion 250c formed into a taper shape radially expanded toward an end surface, on an inner peripheral surface of a base end portion 250b.

The tapered portion 250c abuts on the C-ring 270. In a state where the tapered portion 250c abuts on the C-ring 270, the stopper 250 any more cannot axially move toward the other-end 21b of the piston rod 21.

The C-ring 270 is a ring formed having a circular cross-sectional surface. The C-ring 270 is formed into a C-shaped ring shape whose periphery partially opens. The C-ring 270 is fitted to the ring groove 21e by a force that attempts to contract to an inner periphery. The C-ring 270 abuts on the tapered portion 250c of the stopper 250 to specify an axial position of the base end portion 250b of the stopper 250.

The following describes an assembly procedure of the piston 20.

First, the flux ring 35 is preliminarily integrated with the plate 40 to be attached to the piston core 30 integrally assembled. Specifically, the plate 40 is fitted to the outer periphery of the small-diameter portion 30a of the first core 31 of the piston core 30 to be abutted on the stepped portion 30d of the first core 31. In this state, the plate 40 only abuts on the stepped portion 30d, and is not axially fixed.

Next, the piston rod 21 and the stopper 250 are assembled. First, the C-ring 270 is fitted to the ring groove 21e of the piston rod 21. Then, the stopper 250 is fitted to the one-end 21a of the piston rod 21. The C-ring 270 abuts on the tapered portion 250c on the inner peripheral surface of the base end portion 250b, and thereby an axial position of the stopper 250 is specified.

Last, the piston rod 21 and the piston core 30 are assembled. Specifically, the female screw 31c of the first core 31 of the piston core 30 is screwed with the male screw 21d of the piston rod 21. At this time, between the distal end portion 33e of the piston core 30 and the one-end 21a of the piston rod 21, the O-ring 34 is preliminarily inserted.

Then, as the piston core 30 is rotated with respect to the piston rod 21, between the stepped portion 30d of the first core 31 of the piston core 30 and the distal end portion 250a of the stopper 250, the plate 40 preliminarily attached to the piston core 30 is sandwiched. This completes the assembly of the piston 20.

Thus, a fastening power of the first core 31 of the piston core 30 with respect to the piston rod 21 presses the plate 40 to the stopper 250 to be fixed. Accordingly, only fastening the piston core 30 to the piston rod 21 facilitates the assembly of the piston 20. Since the respective members of the piston 20 can be firmly fixed by the fastening power of the piston core 30, rotation of the respective members is prevented, and vibration is reduced.

With the above modification, similarly, the plate 40 pressed into the one-end 35a of the flux ring 35 and bonded by brazing is sandwiched between the stopper 250 and the stepped portion 30d of the piston core 30, and thereby the flux ring 35 is axially fixed to the piston core 30. In view of this, it is not necessary to dispose a member for fixing the flux ring 35 to the piston core 30 on the other-end 35b side of the flux ring 35. Accordingly, the whole length of the piston 20 of the damper 200 can be shortened.

The following summarizes configurations, actions, and effects according to the embodiment of the present invention.

The dampers 100 and 200 include the cylinder 10, the piston 20, and the piston rod 21. The cylinder 10 seals the magneto-rheological fluid. The magneto-rheological fluid has the apparent viscosity that varies due to the action of the magnetic field. The piston 20 is slidably disposed in the cylinder 10. The piston 20 defines the pair of fluid chambers 11, 12 in the cylinder 10. The piston rod 21 is coupled to the piston 20 to extend to the outside of the cylinder 10. The piston 20 includes the piston core 30, the flux ring 35, the plate 40, and the fixing nut 50 or the stopper 250. The piston core 30 is mounted on the end portion of the piston rod 21. The piston core 30 has the outer periphery on which the coil 33a is disposed. The flux ring 35 surrounds the outer periphery of the piston core 30 and forms the flow passage 22 for the magneto-rheological fluid with the piston core 30. The plate 40 is formed into the ring shape to be disposed on the outer periphery of the piston rod 21, has the outer peripheral surface 40b housed in the one-end 35a of the flux ring 35, and is bonded on the flux ring 35 by the metal layer 60 by brazing. The fixing nut 50 or the stopper 250 sandwiches the plate 40 with the piston core 30.

In this configuration, the plate 40 housed in the one-end 35a of the flux ring 35 and bonded by brazing is sandwiched between the fixing nut 50 or the stopper 250, and the piston core 30, and thereby the flux ring 35 is axially fixed to the piston core 30. In view of this, it is not necessary to dispose a member for fixing the flux ring 35 to the piston core 30 on the other-end 35b side of the flux ring 35. Accordingly, the whole length of the piston 20 of the damper 100 can be shortened.

The flux ring 35 includes the annular recess 35e formed as axially hollowing in the depressed shape from the one-end 35a. The outer peripheral surface 40b of the plate 40 is housed in the annular recess 35e.

In this configuration, the outer peripheral surface 40b of the plate 40 is housed in the annular recess 35e. In view of this, it is not necessary to form, for example, a projecting portion on the plate 40 to attach the plate 40 to the flux ring 35. Thus, the plate 40 can be formed into a simple flat plate shape. As a result, the production cost of the dampers 100 and 200 can be reduced.

The flux ring 35 includes the small-diameter portion 35h formed to have the small outer diameter compared with other part, on the one-end 35a side. The axial length of the small-diameter portion 35h is set equal to or more than the depth of the annular recess 35e.

In this configuration, the small-diameter portion 35h having the length equal to or more than the depth of the annular recess 35e is disposed on the one-end 35a side of the flux ring 35. In view of this, even if the one-end 35a side of the flux ring 35 radially bulges outside when the plate 40 is housed in the annular recess 35e by press-fitting or the like, on the sliding surface of the cylinder 10 and the piston 20, the occurrence of the scoring or the like can be prevented. In addition, since it is not necessary to, for example, reprocess the outer diameter of the flux ring 35 after the plate 40 is housed in the flux ring 35 by press-fitting or the like, the production cost of the dampers 100 and 200 can be reduced.

The axial position of the flux ring 35 is specified by abutting the stepped portion 35g of the annular recess 35e on the one-end surface 40c of the plate 40.

In this configuration, the stepped portion 35g of the annular recess 35e abuts on the one-end surface 40c of the plate 40 sandwiched between the fixing nut 50 or the stopper 250, and the piston core 30, and thereby the axial position of the flux ring 35 with respect to the piston core 30 is specified. Thus, the plate 40 facilitates setting of the axial positional relationship of the piston core 30 and the flux ring 35.

The flux ring 35 is bonded on the plate 40 by the metal layer 60 formed between the inner peripheral surface 35f of the annular recess 35e and the outer peripheral surface 40b of the plate 40.

The metal layer 60 is made of the copper based metal flown into between the plate 40 and the flux ring 35 from the one-end 35a side of the flux ring 35 in the melted state.

In these configurations, the melted copper based metal flows into between the plate 40 and the flux ring 35 from the one-end 35a side of the flux ring 35, and coagulates after cooling to become the metal layer 60. In view of this, the flux ring 35 and the plate 40 are strongly bonded by the metal layer 60, in addition that the outer peripheral surface 40b of the plate 40 is attached to the inner peripheral surface 35f of the flux ring 35 by press-fitting or the like. In these configurations, the melted metal axially flows into from the other-end surface 40d of the plate 40. In view of this, compared with a case where the melted metal radially flows into from the outer peripheral surface, before and after the brazing work, it can be easily visually confirmed whether the metal for brazing is placed or not and whether the metal layer 60 is formed or not.

The flow passage 22 continuously opens in the ring shape on the other-end 35b side of the flux ring 35.

In this configuration, since a member that couples the flux ring 35 to the piston core 30 is not disposed on the other-end 35b side of the flux ring 35, the flow passage 22 continuously opens in the ring shape on the other-end 35b side. As a result, the flow resistance of the flow passage 22 can be reduced.

The embodiments of the present invention described above are merely illustration of some application examples of the present invention and not of the nature to limit the technical scope of the present invention to the specific constructions of the above embodiments.

For example, in the dampers 100 and 200, the pair of wirings that supply the current to the coil 33a pass through the inner periphery of the piston rod 21. Accordingly, an earth to let the current applied to the coil 33a escape to the outside can be omitted. However, instead of the configuration, a configuration may be employed such that only one wiring for applying the current to the coil 33a passes through the inside of the piston rod 21 so as to be earthed to the outside via the piston rod 21 itself.

The present application claims a priority based on Japanese Patent Application No. 2015-176890 filed with the Japan Patent Office on Sep. 8, 2015, all the contents of which are hereby incorporated by reference.

1. A magneto-rheological fluid damper comprising:
a cylinder configured to seal a magneto-rheological fluid, the magneto-rheological fluid having an apparent viscosity that varies due to an action of a magnetic field;
a piston slidably disposed in the cylinder, the piston defining a pair of fluid chambers in the cylinder; and
a piston rod coupled to the piston to extend to an outside of the cylinder, wherein
the piston includes
a piston core mounted on an end portion of the piston rod, the piston core having an outer periphery on which a coil is disposed;
a ring body that surrounds the outer periphery of the piston core, the ring body forming a flow passage for the magneto-rheological fluid with the piston core;
a plate formed into a ring shape to be disposed on the outer periphery of the piston rod, the plate having an outer edge housed in one end of the ring body, the plate being bonded on the ring body by a metal layer by brazing; and
a stopper that sandwiches the plate with the piston core,
the ring body includes an annular recess formed into a depressed shape axially from the one end, and
the plate includes an outer peripheral surface that abuts an inner peripheral surface of the annular recess, and an end surface that abuts a bottom surface of the annular recess.

2. (canceled)

3. The magneto-rheological fluid damper according to claim 1, wherein
the ring body includes a small-diameter portion formed to have a small outer diameter compared with another part, on a side of the one end, and
the small-diameter portion has an axial length set equal to or more than a depth of the annular recess.

4. The magneto-rheological fluid damper according to claim 1, wherein
an axial position of the ring body is specified by abutting the end surface of the plate on bottom surface of the annular recess.

5. The magneto-rheological fluid damper according to claim 1, wherein
the ring body is bonded on the plate by the metal layer formed at least one of between the inner peripheral surface of the annular recess and the outer peripheral surface of the plate, and between the bottom surface of the annular recess and the end surface of the plate.

6. The magneto-rheological fluid damper according to claim 1, wherein
the metal layer is made of a copper based metal flown into between the plate and the ring body from the one end side of the ring body in a melted state.
